(19) United States
(12) Patent Application Publication
(10) Pub. No.: US 2026/0290870 A1
(43) Pub. Date: Sep. 24, 2026

(54) FUEL CELL STACK AND ASSEMBLING METHOD OF FUEL CELL STACK

(71) Applicant: Honda Motor Co., Ltd., Tokyo (JP)

(72) Inventors: Takuma Nozaki, Saitama (JP); Kenji Sasaki, Saitama (JP)

(21) Appl. No.: 19/574,312

(22) Filed: Mar. 21, 2026

(30) Foreign Application Priority Data
Mar. 24, 2025 (JP) 2025-047622

(51) Int. Cl. H01M 8/2475

(52) U.S. Cl. CPC H01M 8/2475

(57) ABSTRACT

A fuel cell stack including a cell stacked body including a plurality of power generation cells stacked in a predetermined direction, a housing including a plurality of side walls formed in a substantially plate shape and forming an accommodation space in which the cell stacked body is accommodated, an end unit attached to an end portion of the housing in the predetermined direction so as to cover an opening of the housing, a first fastening member that fastens the plurality of side walls to each other through a first gasket; and a second fastening member that fastens the housing and the end unit through a second gasket. The first gasket is a cured liquid gasket, and the second gasket is an elastic gasket having an elasticity.

### CROSS-REFERENCE TO RELATED APPLICATION

This application is based upon and claims the benefit of priority from Japanese Patent Application No. 2025-047622 filed on March 24, 2025, the content of which is incorporated herein by reference.

### BACKGROUND OF THE INVENTION

### Field of the Invention

This invention relates to a fuel cell stack and an assembling method of a fuel cell.

### Description of the Related Art

In recent years, technological developments have been made on a fuel cell that contribute to energy efficiency in order to ensure access to energy that is affordable, reliable, sustainable and advanced by more people. As a conventional technology related to a fuel cell stack used in this type of fuel cell, a fuel cell stack in which a case and an end plate are fastened via a cured liquid gasket has been known. Such a fuel cell stack is described in, for example, Japanese Unexamined Patent Publication No. 2022-066743 (JP2022-066743A). In the fuel cell stack described in JP2022-066743A, a notch is provided on the mating surface between the case and the end plate, and a cured liquid gasket is disposed in the notch.

In this type of fuel cell stack, the end plate may be removed for maintenance or other reasons and then reattached. Therefore, in a configuration in which the case and the end plate are fastened via a cured liquid gasket as described in JP2022-066743A, when the end plate is removed, the liquid gasket may peel off and foreign matter (peeled pieces) may enter the case, which may adversely affect the operation of the fuel cell.

### SUMMARY OF THE INVENTION

An aspect of the present invention is a fuel cell stack including a cell stacked body including a plurality of power generation cells stacked in a predetermined direction, a housing including a plurality of side walls formed in a substantially plate shape and forming an accommodation space in which the cell stacked body is accommodated, an end unit attached to an end portion of the housing in the predetermined direction so as to cover an opening of the housing, a first fastening member that fastens the plurality of side walls to each other through a first gasket, and a second fastening member that fastens the housing and the end unit through a second gasket. The first gasket is a cured liquid gasket, and the second gasket is an elastic gasket having an elasticity.

Another aspect of the present invention is an assembling method of a fuel cell stack including forming a housing by fastening a plurality of side walls formed in a substantially plate shape through a first gasket with a first fastening member, stacking a plurality of power generation cells in an accommodation space in the housing through an opening at an end portion of the housing in a predetermined direction to form a cell stacked body, and attaching an end unit to an end surface of the housing in the predetermined direction so as to cover the opening of the housing through a second gasket with a second fastening member. The first gasket is a liquid gasket, and the second gasket is an elastic gasket having an elasticity, and the attaching the end unit includes attaching the end unit after the liquid gasket has cured.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating an overall configuration of a fuel cell stack according to an embodiment of the present invention;

FIG. 2 is a cross-sectional view taken along line II-II of FIG. 1;

FIG. 3 is an enlarged view of a part III in FIG. 2;

FIG. 4 is a cross-sectional view taken along line IV-IV of FIG. 1;

FIG. 5 is an enlarged view of a part V in FIG. 4;

FIG. 6 is a perspective view illustrating a configuration of a corner portion of a rear end surface of a case in FIG. 2;

FIG. 7 is a diagram illustrating a step of removing a part of a liquid gasket; and

FIG. 8 is a flowchart illustrating an example of an assembling procedure of the fuel cell stack by an assembling method of a fuel cell stack according to the embodiment of the present invention.

### DETAILED DESCRIPTION OF THE INVENTION

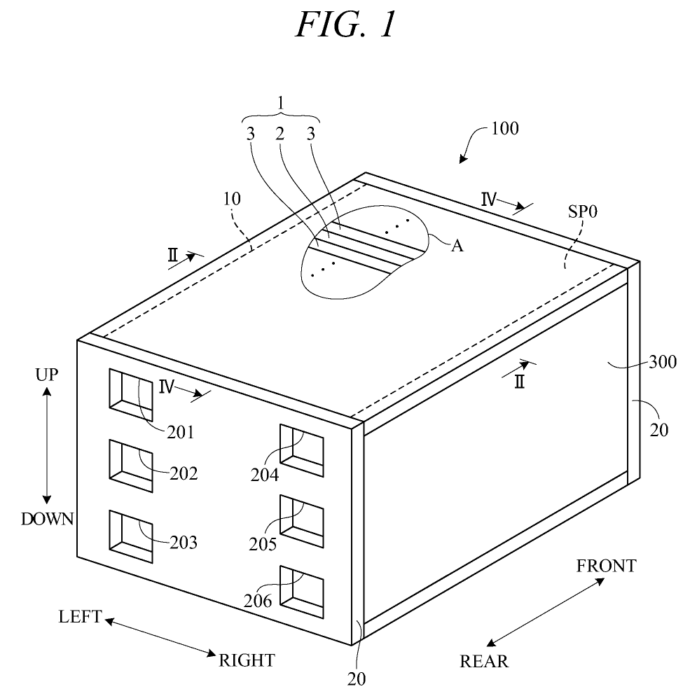

Hereinafter, embodiments of the present invention will be described with reference to FIGS. 1 to 8. A fuel cell stack according to an embodiment of the present invention is one of main components of a fuel cell. The fuel cell can be mounted on a vehicle, for example, and is capable of generating electric power for actuating the vehicle. It is also possible to mount the fuel cell on movable bodies, such as aircraft or ships other than vehicles, robots, and various industrial machines.

First, an overall configuration of a fuel cell stack will be described. FIG. 1 is a perspective view schematically illustrating an overall configuration of a fuel cell stack 100 according to an embodiment of the present invention. Hereinafter, for the sake of convenience, three-axis directions orthogonal to one another as illustrated in the drawings are defined as a front-rear direction, a left-right direction, and an up-down direction, and a configuration of each unit will be described in accordance with such definitions. The lower side in the up-down direction in FIG. 1 corresponds to a gravity direction. The front-rear direction in FIG. 1 corresponds to a stacking direction of the fuel cell stack 100. The front-rear direction and the left-right direction in FIG. 1 are not necessarily identical to a front-rear direction and a left-right direction of a vehicle.

As illustrated in FIG. 1, the fuel cell stack 100 includes: a cell stacked body 10; end units 20, which are disposed at both end portions of the cell stacked body 10 in the front-rear direction; and a case 30, which is disposed around the cell stacked body 10 so as to surround the cell stacked body 10. Its entirety has a substantially rectangular parallelepiped shape. A length of the fuel cell stack 100 in the left-right direction is longer than a length of the fuel cell stack 100 in the up-down direction.

The case 30 has four substantially rectangular side walls 300, which respectively face an upper surface, a left surface, a lower surface, and a right surface of the cell stacked body 10. These four side walls 300 define a substantially box-shaped accommodation space SP0 in which the front surface and the rear surface are open. The front surface and the rear surface of the case 30 each are covered with the end unit 20 having a substantially rectangular plate shape.

In a part “A” in FIG. 1, a part of an upper wall 31 of the case 30 is indicated in a broken state. As indicated by the part “A” in FIG. 1, the cell stacked body 10 is configured by stacking a plurality of power generation cells 1 (for the sake of convenience, only a single power generation cell 1 is illustrated) in the front-rear direction, and has a substantially rectangular parallelepiped shape as a whole. The power generation cell 1 includes: a unitized electrode assembly (hereinafter, referred to as UEA) 2 having a membrane electrode assembly including an electrolyte membrane and an electrode; and separators 3, which are respectively disposed on both front and rear sides of the UEA 2 to sandwich the UEA 2. The UEA 2 and the separator 3 are alternately disposed in the front-rear direction. The separator 3 includes, for example, a pair of front and rear metal thin plates each having a corrugated cross-section, and outer peripheral portions of the pair of thin plates are bonded to each other to be integrally configured. A cooling flow path through which a cooling medium (for example, water) flows is formed inside the pair of thin plates, and a power generation surface of the power generation cell 1 is cooled by the flow of the cooling medium. The UEA 2 can also be referred to as a membrane electrode structure.

The separator 3 on the front side of the UEA 2 is a separator on an anode side (an anode separator), and an anode flow path through which a fuel gas containing hydrogen flows is formed between the anode separator 3 and the membrane electrode assembly of the UEA 2. The separator 3 on the rear side of the UEA 2 is a separator on a cathode side (a cathode separator), and a cathode flow path through which an oxidant gas containing oxygen flows is formed between the cathode separator 3 and the membrane electrode assembly of the UEA 2. The front side of the UEA 2 may be the cathode separator, and its rear side may be the anode separator.

The UEA 2 includes: a membrane electrode assembly (hereinafter, referred to as MEA); and a thin plate-shaped frame made of resin that supports the periphery of the MEA. The MEA includes an electrolyte membrane, an anode electrode provided on a front surface of the electrolyte membrane, and a cathode electrode provided on a rear surface of the electrolyte membrane. The electrolyte membrane is, for example, a solid polymer electrolyte membrane. The anode electrode includes: an electrode catalyst layer, which is formed on the front surface of the electrolyte membrane, and which serves as a reaction field of an electrode reaction; and a gas diffusion layer, which is provided on the front surface of the electrode catalyst layer, and which diffuses and supplies a fuel gas. The cathode electrode includes: an electrode catalyst layer, which is formed on the rear surface of the electrolyte membrane, and which serves as a reaction field of an electrode reaction; and a gas diffusion layer, which is provided on the rear surface of the electrode catalyst layer, and which diffuses and supplies an oxidant gas.

At the anode electrode, the fuel gas (hydrogen) supplied through the anode flow path and the gas diffusion layer is ionized by the action of the catalyst, passes through the electrolyte membrane, and moves toward the cathode electrode side. Electrons generated at this time pass through an external circuit, and are extracted as electric energy. At the cathode electrode, the oxidant gas (oxygen) supplied through the cathode flow path and the gas diffusion layer reacts with hydrogen ions guided from the anode electrode and electrons moved from the anode electrode, and generates water. The generated water gives an appropriate humidity to the electrolyte membrane, and excessive water is discharged to the outside of the UEA 2.

Through-holes 201 to 206, which penetrate through the end unit 20 in the front-rear direction, are open in one (for example, the rear side) of the end units 20. The through-hole 201 is a through-hole for supplying fuel gas into the cell stacked body 10. The through-hole 202 is a through-hole for discharging a cooling medium from the cell stacked body 10 to the outside. The through-hole 203 is a through-hole for discharging the oxidant gas from the cell stacked body 10 to the outside. The through-hole 204 is a through-hole for supplying the oxidant gas into the cell stacked body 10. The through-hole 205 is a through-hole for supplying the cooling medium to the inside of the cell stacked body 10. The through-hole 206 is a through-hole for discharging the fuel gas from the cell stacked body 10 to the outside.

A plurality of flow paths (manifolds) extending in the front-rear direction are formed at both end portions in the left-right direction of the cell stacked body 10 to communicate with the through-holes 201 to 206. The fuel gas supplied through the through-hole 201 is guided to the anode flow path inside the cell stacked body 10, and the oxidant gas supplied through the through-hole 204 is guided to the cathode flow path. Thus, electric power is generated in the power generation cell 1. The fuel gas and the oxidant gas that have been supplied are respectively discharged from the cell stacked body 10 through the through-holes 206 and 203. The cooling medium is supplied to the cell stacked body 10 through the through-hole 205, and thus cools the power generation surface. The cooling medium that has passed through the cell stacked body 10 is discharged through the through-hole 202.

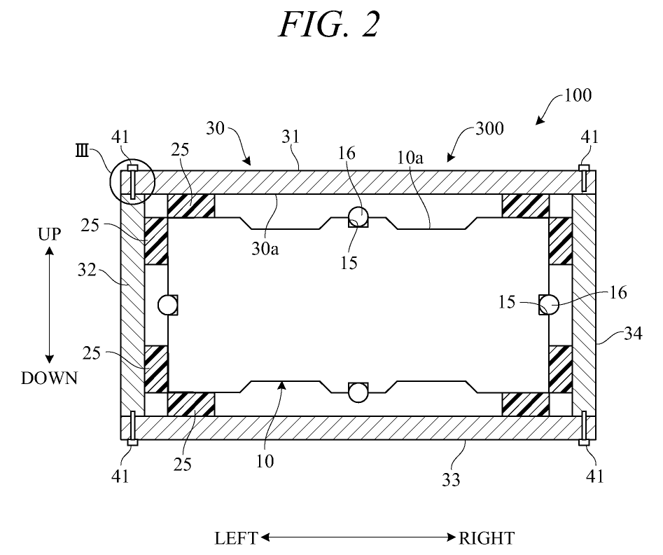

FIG. 2 is a cross-sectional view taken along line II-II in FIG. 1. In FIG. 2, for the sake of convenience, only the outer edge shape of the cell stacked body 10 is illustrated. As illustrated in FIG. 2, the case 30 includes four side walls 300, that is, the upper wall 31 and a lower wall 33, which extend in a substantially horizontal direction, and a left wall 32 and a right wall 34, which extend in a substantially vertical direction. The four side walls 300 each are made of metal such as iron or aluminum. End portions of the four adjacent side walls 300 (31 to 34) are fastened to each other with bolts 41, and the case 30 is configured.

A holding bar 25 is interposed as an impact receiving member or a restraining member between an inner wall surface (a case inner wall surface) 30a of the side wall 300 of the case 30 and an outer side surface 10a of the cell stacked body 10. The holding bars 25 are disposed in the vicinity of end portions of four sides (an upper side, a left side, a lower side, and a right side) of the cell stacked body 10. In other words, the holding bars 25 are respectively disposed in the vicinity of the four corner portions of the cell stacked body 10, interposing each corner portion between them.

The holding bar 25 has a substantially rectangular cross-section, and extends over substantially the entire length in the front-rear direction of the cell stacked body 10. The plurality of holding bars 25 each have an identical cross-sectional shape. The holding bar 25 is an elastic body of a resin material, rubber, or the like, and is made of an insulator. The holding bar 25 is attached to the case inner wall surface 30a beforehand, for example, and is provided integrally with the case 30. Provision of the holding bars 25 in the vicinity of the corner portion of the cell stacked body 10 makes the vicinity of the corner portion of the cell stacked body 10 abut the holding bars 25, when an impact acts on the case 30 in a direction orthogonal to the stacking direction of the cell stacked body 10. Thus, a positional deviation of the power generation cell 1 can be suppressed effectively.

A plurality of positioning portions 15 each having a recess shape are provided in a peripheral edge portion of the cell stacked body 10. In the case, a plurality of guide members 16 are disposed to respectively correspond to the positioning portions 15. At the time of assembling the fuel cell stack 100, the end unit 20 is horizontally placed, and then the guide member 16 is made to stand up on the end unit 20. In a stand-up state, the guide member 16 has a constant cross-sectional shape from its lower end portion to its upper end portion (from the rear end portion to the front end portion in FIG. 1). The plurality of guide members 16 each have an identical shape, and their cross-sectional shapes are, for example, circular. At the time of assembling the fuel cell stack 100, lower end portions and upper end portions of the plurality of guide members 16 are respectively fit into recess portions or through-holes provided on the end unit 20, and thus the guide members 16 each are held at a predetermined position inside the case.

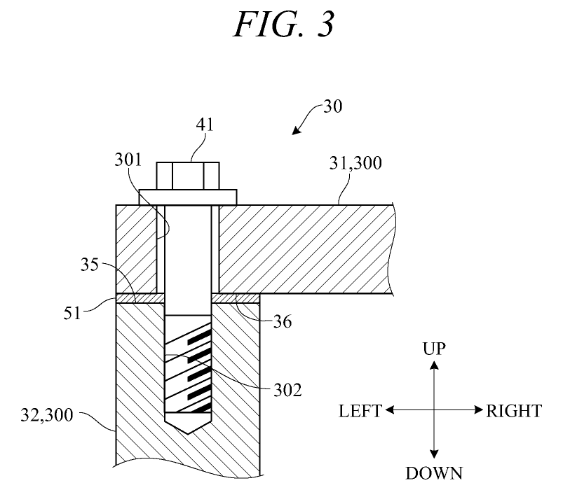

An upper end surface of the left wall 32 and an upper end surface of the right wall 34 are respectively made to abut a lower surface at a left end portion and a lower surface at a right end portion of the upper wall 31. A lower end surface of the left wall 32 and a lower end surface of the right wall 34 are respectively made to abut an upper surface at a left end portion and an upper surface at a right end portion of the lower wall 33. FIG. 3 is an enlarged view of a corner portion (an enlarged view of a part III) of the case 30 in FIG. 2 in which the upper wall 31 and the left wall 32 intersect each other. The other corner portions of the case 30 are also configured in a similar manner to the configuration of FIG. 3.

As illustrated in FIG. 3, an attachment surface 35, which is flat, and which extends in a substantially horizontal direction, is formed on the upper end surface of the left wall 32 by machining. Similarly, an attachment surface 36, which is flat, and which extends in the substantially horizontal direction, is formed on the lower surface at the left end portion of the upper wall 31 by machining. A through-hole 301, which penetrates through the upper wall 31 in the up-down direction, is opened at the left end portion of the upper wall 31. Although not illustrated, a plurality of through-holes 301 are provided at equal intervals or at substantially equal intervals in the front-rear direction. A plurality of screw holes 302 are formed in the front-rear direction on the attachment surface 35 at positions respectively corresponding to the through-holes 301. The bolt 41 is inserted into the through-hole 301. The bolt 41 is screwed into the screw hole 302, and the side walls 300 are fastened to each other, accordingly. A seat surface may be formed by counterboring an upper surface of the upper wall 31 with the through-hole 301 as the center so that a head portion of the bolt 41 does not protrude from the upper surface of the upper wall 31.

A seal material 51 is interposed between the attachment surfaces 35 and 36. The seal material 51 is a cured liquid gasket. That is a gasket cured from a liquid state to a solid state with the lapse of time. Such a gasket is applied to both or one of the attachment surfaces 35 and 36 in a liquid-phase state, and in such a state, the side walls 300 (the upper wall 31 and the left wall 32) are fastened to each other with the bolts 41. Then, when the gasket is cured with the lapse of time, the seal material 51 becomes capable of exhibiting sealing and adhesive properties. The liquid gasket used for the seal material 51 may be any of a silicone-based gasket, a phenol-based gasket, and an acrylic-based gasket. The liquid gasket may have a property of being cured by heating. The seal material 51 has heat resistance that can withstand its use environment. In FIG. 3, the thickness of the seal material 51 is illustrated in an exaggerated manner.

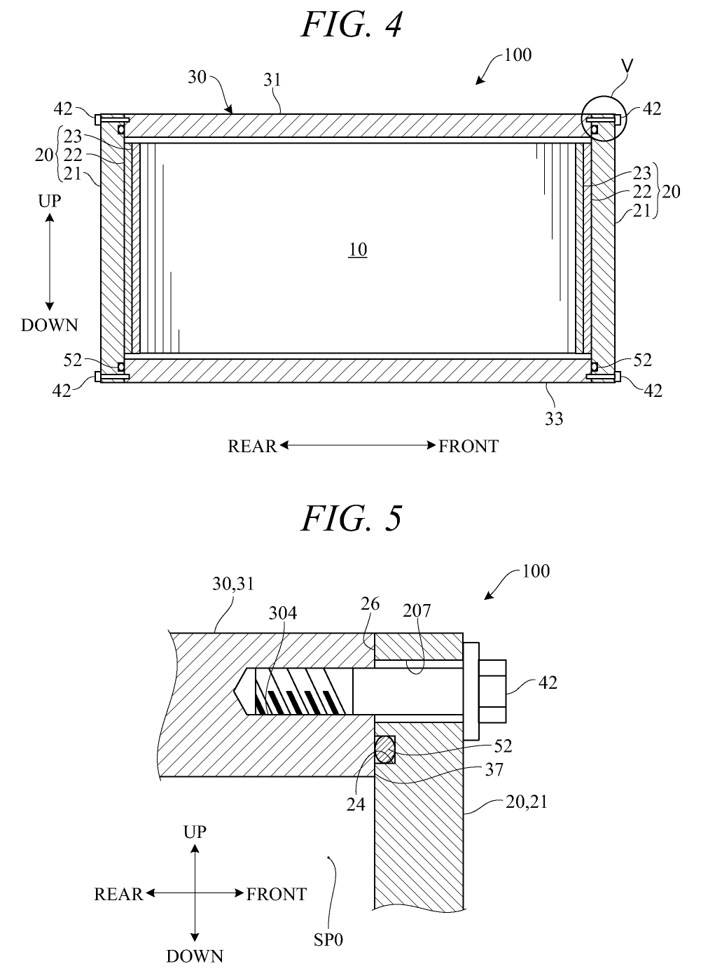

FIG. 4 is a cross-sectional view taken along line IV-IV in FIG. 1. As illustrated in FIG. 4, the end unit 20 includes: a pair of front and rear terminal plates 23, which are respectively disposed outside in the front-rear direction of the cell stacked body 10; a pair of front and rear insulating plates 22, which are respectively disposed outside in the front-rear direction of the pair of front and rear terminal plates 23; and a pair of front and rear end plates 21, which are respectively disposed outside in the front-rear direction of the pair of front and rear insulating plates 22.

The terminal plate 23 is a plate-shaped member, which is made of metal, and which has a substantially rectangular shape, and includes terminal portions for extracting electrical power generated by electrochemical reactions in the cell stacked body 10. The insulating plate 22 is a plate-shaped member, which is made of non-conductive resin or rubber, and which has a substantially rectangular shape, and electrically insulates the terminal plate 23 from the end plate 21. The end plate 21 is a plate-shaped member, which is made of metal or a resin having high strength, and which has a substantially rectangular shape.

A front end surface and a rear end surface of the case 30 are respectively made to abut a rear end surface of the end plate 21 on the front side and a front end surface of the end plate 21 on the rear side, and the case 30 and the end plate 21 are fastened to each other by bolts 42. That is, in FIG. 4, the insulating plate 22 and the terminal plate 23 are disposed inside the case 30, and only the end plate 21 is disposed to face the front end surface and the rear end surface of the case 30. The configuration of the end unit 20 is not limited to this. One of the insulating plate 22 and the terminal plate 23 or both of them may be disposed to face the front end surface and the rear end surface of the case 30.

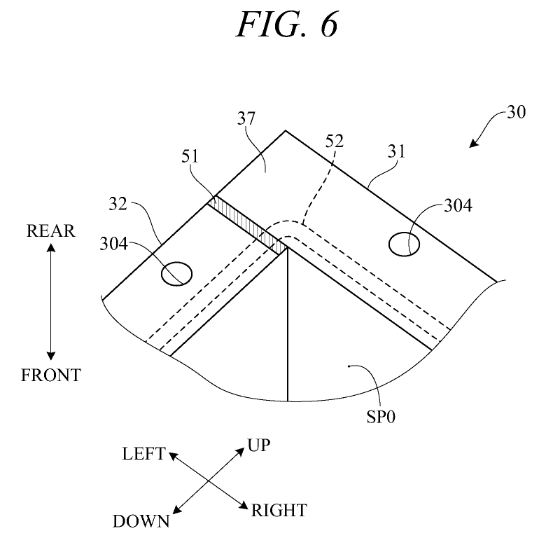

FIG. 5 is an enlarged view (an enlarged view of a part V) of a corner portion of the fuel cell stack 100 of FIG. 4 in which the upper wall 31 and the end unit 20 on the front side (the end plate 21) intersect each other. The other corner portions of the fuel cell stack 100 are configured in a similar manner to the configuration of FIG. 5. As illustrated in FIG. 5, an attachment surface 37, which is flat, and which extends in a substantially vertical direction, is formed on a front end surface of the upper wall 31 by machining. Similarly, an attachment surface 26, which is flat, and which extends in the substantially vertical direction, is formed on the rear end surface of the end plate 21 by machining.

A through-hole 207, which penetrates through the end plate 21 in the front-rear direction, is opened in a peripheral edge portion of the end plate 21. Although not illustrated, a plurality of through-holes 207 are provided at equal intervals or at substantially equal intervals along the peripheral edge portion of the end plate 21. A plurality of screw holes 304 are drilled into the attachment surface 37 at positions respectively corresponding to the through-holes 207. A bolt 42 is inserted into the through-hole 207. The bolt 42 is screwed into the screw hole 304, and the case 30 and end unit 20 (the end plate 21) are fastened to each other, accordingly. A seat surface may be formed by counterboring the front surface of the end plate 21 with the through-hole 207 as the center so that a head portion of the bolt 42 does not protrude from the front surface of the end plate 21.

A recess portion 24 is provided on the attachment surface 26 of the end plate 21 on an inner side of the bolt 42, that is, to be closer to the accommodation space SP0 over the entire circumference of the peripheral edge portion. A seal material 52 is accommodated in the recess portion 24. The seal material 52 is an elastic gasket, which is made of a material such as rubber, and which has elasticity. For example, an O-ring made of a rubber material having a circular cross-sectional shape can be used as the seal material 52. The seal material 52 has heat resistance that can withstand its use environment. When the case 30 and the end plate 21 are fastened to each other, the seal material 52 is crushed and contracted, and thus the attachment surfaces 37 and 26 are sealed to each other. The end plate 21 is fastened to the front end surface of the case 30 after the seal material 51 (the liquid gasket) in FIG. 3 is cured.

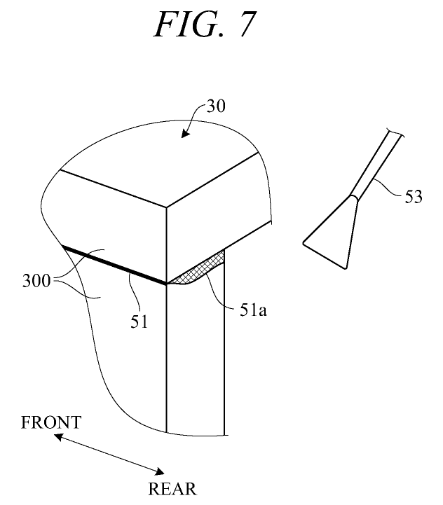

FIG. 6 is a perspective view illustrating a configuration of a corner portion of the rear end surface of the case 30 (the upper wall 31 and the left wall 32). In FIG. 6, the position of the seal material 52 after the end plate 21 is attached is indicated by dotted lines. As illustrated in FIG. 6, a rear end surface of the seal material 51 and the seal material 52 cross each other, and the seal materials 51 and 52 are in contact with each other. The seal material 52 is disposed on an inner side of the screw hole 304, that is, to be closer to the accommodation space SP0. In the present embodiment, the rear end surface of the seal material 51 is formed so that the rear end surface of the seal material 51 is positioned to be flush with the attachment surface 37 (FIG. 5) at a rear end of the case 30. For example, as illustrated in FIG. 7, before the liquid gasket is cured, a portion (a protrusion portion 51a) of the liquid gasket that protrudes from the rear end surface of the side wall 300 of the case 30 is scraped off using a scraper 53. Thus, the rear end surface of the case 30 is formed to be flush with the rear end surface of the seal material 51.

In the present embodiment, after the liquid gasket is cured, the end plate 21 is attached. Therefore, even though the seal material 52 is in contact with the seal material 51, the adhesive force from the seal material 51 does not work on the seal material 52. As a result, it becomes possible to easily detach the end plate 21 together with the seal material 52. In detaching the end plate 21, it becomes possible to prevent the seal material 51 from peeling off due to the seal material 51 adhering to the seal material 52. Thus, it becomes possible to prevent foreign matters such as peeled pieces of the seal material 51 from entering the case.

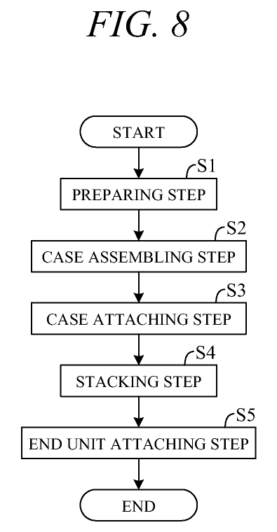

The assembling method of the fuel cell stack 100 according to the present embodiment will be described. FIG. 8 is a flowchart illustrating an example of an assembling procedure of the fuel cell stack 100. As illustrated in FIG. 8, first, in S1 (S denotes a processing step), the side wall 300 of the case 30 is prepared as a preparing step. For example, molded products of the four side walls 300 are formed by casting. Next, the surfaces of the molded products are machined to form the attachment surfaces 35 to 37, and the through-hole 301 and the screw holes 302 and 304 are also formed. Furthermore, the holding bar 25 is attached to the case inner wall surface 30a with a bolt, not illustrated. In the preparing step, the attachment surface 26 of the end plate 21 and the through-hole 207 are also processed.

Next, in S2, as a case assembling step, the side walls 300, which are adjacent to each other, are fastened to each other via the bolts 41 to assemble the case 30. More specifically, the liquid gasket (the seal material 51) is applied to the attachment surfaces 35 and 36 of the side walls 300 (FIG. 3), and the side walls 300 are fastened to each other with the bolts 41 before the liquid gasket is cured. In this situation, a part (the protrusion portion 51a in FIG. 7) that protrudes from the end surface of the side wall 300 is removed using the scraper 53 or the like, and the front end surface and the rear end surface of the case 30 are configured to be flat.

Next, one of the end units 20 (for example, the end unit 20 on the rear side) is mounted on an assembly stand. The seal material 52 is accommodated beforehand in the recess portion 24 on the upper surface of the end plate 21. Next, in S3, as a case attaching step, the case 30 is mounted on the end plate, and the end unit 20 (the end plate 21) and the case 30 are fastened to each other with the bolts 42. The seal material 52 is compressed by the fastening force of the bolts 42, and the contact surfaces between the end plate 21 and the case 30, that is, the attachment surfaces 26 and 37 are sealed to each other.

Next, in S4, as a stacking step, the guide member 16 is supported by the end unit 20 on the lower side, and the guide member 16 is made to stand up inside the case. Furthermore, the plurality of power generation cells 1 are accommodated in the case from above through an opening on the upper surface of the case 30. In this situation, the plurality of power generation cells 1 are accommodated in the case while being positioned along the guide member 16, and the plurality of power generation cells 1 are stacked. Thus, the cell stacked body 10 is configured.

Next, in S5, as an end unit attaching step, the other end plate 21 (for example, the end plate 21 on the front side) is attached to the upper surface of the case 30. In this case, the seal material 52 is accommodated beforehand in the recess portion 24 of the end plate 21. In this state, a pressurizer, not illustrated, is used for applying pressurizing force to the upper surface of the end unit 20. Thus, the end unit 20 is pushed down, a compression load is applied to the cell stacked body 10, and the cell stacked body 10 is compressed. When the end plate 21 abuts the upper end surface of the case 30, the end plate 21 is fastened to the case 30 with the bolts 42. The seal material 52 is compressed by the fastening force of the bolts 42, and the contact surface between the end plate 21 and the case 30, that is, the attachment surfaces 26 and 37 are sealed to each other. Heretofore, assembling of the fuel cell stack 100 is completed.

When it is necessary to disassemble the fuel cell stack 100 for maintenance or the like of the fuel cell stack 100, the bolts 42 are loosened to detach the end plate 21 from the case 30. Thus, it becomes possible to detach the case 30 in which the plurality of (four) side walls 300 are integrated together from the periphery of the cell stacked body 10, so the maintenance is enabled. Therefore, there is no need to disassemble the case 30 at the time of maintenance, and the plurality of side walls 300 of the case 30 remain integrally fastened through the seal material 51. Thus, it becomes possible to easily carry out the maintenance with no generation of peeled pieces that have been peeled off from the seal material 51.

According to the present embodiment, the following operation and effects are achievable.

(1) The fuel cell stack 100 includes: the cell stacked body 10, which is configured by stacking a plurality of power generation cells 1 in the front-rear direction (a predetermined direction); the case 30 including a plurality of side walls 300, each of which has a substantially plate shape, and in which the accommodation space SP0 for accommodating the cell stacked body 10 is defined; the end units 20 each being attached to the front end portion and the rear end portion of the case to cover an opening of the case 30; the bolt 41 for fastening the plurality of side walls 300 to each other through the seal material 51; and the bolt 42 for fastening the case 30 to each of the end units 20 (the end plate 21) through the seal material 52 (FIGS. 1, 3, and 5). The seal material 51 is a cured liquid gasket, and the seal material 52 is an elastic gasket having elasticity.

In this configuration, when it is necessary to disassemble the fuel cell stack 100 for maintenance or the like, no liquid gasket is present between the case 30 and the end plate 21. Therefore, it becomes possible to easily detach the end plate 21 from the case 30 without generating foreign matters such as peeled pieces of the liquid gasket, and it becomes possible to prevent foreign matters from entering the case. On the other hand, the plurality of side walls 300 that do not have to be disassembled at the time of maintenance are fastened to each other through the seal material 51, which is the liquid gasket, so that the case 30 having a high sealing property can be configured at low cost.

(2) The end units 20 (the end plates 21) include: the attachment surfaces 26, which are respectively made to abut the attachment surfaces 37 of the front end surfaces and the rear end surfaces of the plurality of side walls 300; and the recess portion 24, which is provided on each of the attachment surfaces 26 along an edge portion of each of the end plates 21, and which is used for accommodating the seal material 52 (FIG. 5). In this manner, the recess portion 24 is provided on the end surface of the end plate 21 to accommodate the seal material 52, instead of the end surface of the case 30 in which the liquid gasket is present, so that the attachment surfaces 26 and 37 on which the case 30 and the end plate 21 abut each other can be satisfactorily sealed without damaging the liquid gasket.

(3) The front end surface and the rear end surface of the seal material 51 are formed on the same plane as the attachment surfaces 37 of the plurality of side walls 300 in the front-rear direction (FIG. 6). Thus, a satisfactory sealing property is obtainable without an occurrence of a step on a position where the cured liquid gasket (the seal material 51) and the elastic gasket (the seal material 52) cross each other.

(4) An assembling method of a fuel cell stack includes: a case assembling step of forming the case 30 by fastening a plurality of side walls 300 each having a substantially plate shape through the seal material 51 with the bolt 41; a stacking step of stacking a plurality of power generation cells 1 in the accommodation space SP0 inside the case through an opening at an end portion of the case 30 to form the cell stacked body 10; and an end unit attaching step of attaching the end unit 20 to an end surface of the case 30 to cover the opening of the case 30 through the seal material 52 with the bolt 42 (FIG. 8). The seal material 51 is a liquid gasket, and the seal material 52 is an elastic gasket having elasticity. The step of attaching the end unit 20 includes attaching the end unit 20 after the liquid gasket is cured. Thus, when the end unit 20 is detached, it becomes possible to prevent foreign matters (peeled pieces of the liquid gasket or the like) from entering the case.

(5) The step of forming the case 30 includes a step of removing the liquid gasket (the protrusion portion 51a) that protrudes from the end surface in the front-rear direction of the case 30 before the liquid gasket is cured (FIG. 7). Thus, it becomes possible to easily form the end surface of the case 30 to be flat using the scraper 53 or the like. As a result, it becomes possible to satisfactorily make the seal material 52 abut the end surface of the case 30 including the seal material 51, and a satisfactory sealing property is obtainable.

The above embodiment can be modified to various forms. Hereinafter, some modified examples will be described. In the above embodiment, the case 30 as a housing is configured using the substantially rectangular upper wall 31, left wall 32, lower wall 33, and right wall 34, but any configuration of the housing may be used as long as it has a plurality of substantially plate-shaped side walls 300 and forms an accommodation space SP0 for the cell stacked body 10. In the above embodiment, the end plate 21 is attached to the end portion of the case 30, but the end plate 21 and the insulating plate 22, or the end plate 21, the insulating plate 22, and the terminal plate 23 may be attached to the end portion of the case 30.

In the above embodiment, the cured liquid gasket is used as the seal material 51 (a first gasket), and the plurality of side walls 300 are fastened by the bolts 41 (first fastening members) through the first gasket, but the configuration of the first fastening member is not limited to that described above. In the above embodiment, the elastic gasket is used as the seal material 52 (a second gasket), and the case 30 and the end unit 20 are fastened by the bolts 42 (second fastening members) through the second gasket, but the configuration of the second fastening member is not limited to that described above.

In the above embodiment, the attachment surface 26 (an abutment surface) against which the end surface of the case 30 abuts is provided on the surface of the end unit 20 (end plate 21), and the recess portion 24 for accommodating the seal material 52 is provided on the attachment surface 26, but the configuration of an end unit is not limited to that described above. In the above embodiment, the scraper 53 is used to remove the protrusion portion 51a of the liquid gasket which protrudes from the end surface of the case 30, but other means may be used to remove the protrusion portion 51a of the liquid gasket.

The above embodiment can be combined as desired with one or more of the above modifications. The modifications can also be combined with one another.

According to the present invention, it is possible to prevent foreign matter from entering a housing when an end unit is removed.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body including a plurality of power generation cells stacked in a predetermined direction;
a housing including a plurality of side walls formed in a substantially plate shape and forming an accommodation space in which the cell stacked body is accommodated;
an end unit attached to an end portion of the housing in the predetermined direction so as to cover an opening of the housing;
a first fastening member that fastens the plurality of side walls to each other through a first gasket; and
a second fastening member that fastens the housing and the end unit through a second gasket, wherein
the first gasket is a cured liquid gasket, and the second gasket is an elastic gasket having an elasticity.

2. The fuel cell stack according to claim 1, wherein
the end unit has an abutment surface abutting against end surfaces of the plurality of side walls in the predetermined direction, and a recess provided on the abutment surface along an edge portion of the end unit so as to accommodate the second gasket.

3. The fuel cell stack according to claim 2, wherein
an end surface of the first gasket in the predetermined direction is formed on a same plane as the end surfaces of the plurality of side walls in the predetermined direction.

4. The fuel cell stack according to claim 3, wherein
the second gasket is disposed so as to intersect the end surface of the first gasket in the predetermined direction.

5. The fuel cell stack according to claim 2, wherein
a screw hole is provided at the end portion of the housing in the predetermined direction,
the second fastening member is a bolt screwed into the screw hole through a through hole provided in the end unit, and
the second gasket is disposed on a side of the accommodation space of the second fastening member.

6. An assembling method of a fuel cell stack comprising:
forming a housing by fastening a plurality of side walls formed in a substantially plate shape through a first gasket with a first fastening member;
stacking a plurality of power generation cells in an accommodation space in the housing through an opening at an end portion of the housing in a predetermined direction to form a cell stacked body; and
attaching an end unit to an end surface of the housing in the predetermined direction so as to cover the opening of the housing through a second gasket with a second fastening member, wherein
the first gasket is a liquid gasket, and the second gasket is an elastic gasket having an elasticity, and
the attaching the end unit includes attaching the end unit after the liquid gasket has cured.

7. The assembling method of the fuel cell stack according to claim 6, wherein
the forming the housing includes removing the liquid gasket protruding from the end surface of the housing in the predetermined direction before the liquid gasket is cured.
